(19) United States
(12) Patent Application Publication
(10) Pub. No.: US 2021/0218152 A1
(43) Pub. Date: Jul. 15, 2021

(54) ANTENNA APPARATUS

(71) Applicant: HUAWEI TECHNOLOGIES CO., LTD., Shenzhen (CN)

(72) Inventors: Weihong XIAO, Dongguan (CN); Linlin WANG, Xi'an (CN); Chaohui YANG, Xi'an (CN); Tao LIU, Xi'an (CN); Lei CHEN, Xi'an (CN)

(21) Appl. No.: 17/213,555

(22) Filed: Mar. 26, 2021

Related U.S. Application Data
(63) Continuation of application No. PCT/CN2019/102893, filed on Aug. 27, 2019.

(30) Foreign Application Priority Data
Sep. 27, 2018 (CN) 201811130003.1

(51) Int. Cl. H01Q 21/00

(52) U.S. Cl. CPC H01Q 21/0025; H01Q 21/061

(57) ABSTRACT

This application provides an antenna apparatus. The antenna apparatus includes a signal processing module and an antenna. The signal processing module is configured to perform feeding for a signal received or to be sent by the antenna. The antenna is configured to send or receive the signal. The signal processing module is separately connected to the antenna and a radio frequency unit in a pluggable manner. In addition, the signal processing module includes at least a feeding network. By using the antenna apparatus provided in this application, signal processing components are integrated into a pluggable module. In this way, the antenna apparatus can use different signal processing modules as required by different scenarios.

### CROSS-REFERENCE TO RELATED APPLICATIONS

This application is a continuation of International Application No. PCT/CN2019/102893, filed on Aug. 27, 2019, which claims priority to Chinese Patent Application No. 201811130003.1, filed on Sep. 27, 2018. The disclosures of the aforementioned applications are hereby incorporated by reference in their entireties.

### TECHNICAL FIELD

This application relates to the field of wireless communication technologies, and in particular, to an antenna apparatus.

### BACKGROUND

Propelled by never-ending communications development, communications systems are upgraded rapidly. A single base station antenna form can hardly meet evolving requirements. In addition, with refinement of communications standards, new specific requirements are imposed on previous antenna forms, to adapt to various emerging complex and diversified communication scenarios. However, at present, an antenna delivered from the factory is configured for only a single scenario, because the frequency band of the antenna is fixed. Prior art antenna apparatus cannot be easily adapted to complex and diversified communication scenarios. As a result, requirements of different scenarios cannot be satisfied with relative ease.

### SUMMARY

This application provides an antenna apparatus, to improve adaptability of the antenna apparatus.

According to a first aspect, an antenna apparatus is provided. The antenna apparatus includes a signal processing module and an antenna. The signal processing module is configured to perform feeding for a signal received or to be sent by the antenna. The antenna is configured to send or receive the signal. The signal processing module uses a pluggable manner, and is separately connected to or disconnected from the antenna and a radio frequency unit in a pluggable manner. For example, when the signal processing module is plugged into the antenna apparatus, the signal processing module connects the radio frequency unit to the antenna; and when the signal processing module is unplugged from the antenna apparatus, the radio frequency unit is disconnected from the antenna. In addition, a signal processing circuit is disposed in the signal processing module. The signal processing circuit is correspondingly connected to the radio frequency unit and the antenna. The signal processing circuit includes at least a feeding network, so as to process a signal sent by the radio frequency unit and transmit a processed signal to the antenna, or to process the signal received by the antenna and transmit a processed signal to the radio frequency unit.

It can be learned that, by using the antenna apparatus provided in this application, a signal processing component is designed as a pluggable module to facilitate replacement. In this way, the antenna apparatus can use different signal processing modules conveniently as required by an actual scenario, enhancing flexibility and adaptability of the antenna apparatus.

The signal processing circuit provided in this embodiment of this application further includes a filter unit connected to the feeding network. The filter unit performs filtering on a signal. The filter unit may include different filter components, for example, a duplexer or a filter. The duplexer or the filter may be selected based on an actual requirement.

Therefore, when the signal processing circuit includes a filter or a duplexer, the radio frequency unit connected to the signal processing module may not need to include a filter or a duplexer. This can reduce heat dissipation, power consumption, and the like of the radio frequency unit, thereby reducing the complexity in the designing of the radio frequency unit connected to the antenna apparatus provided in this application.

The following several connection manners are available for the signal processing circuit provided in the embodiments of this application:

In a first connection manner, the signal processing module includes only the feeding network. Optionally, the signal processing module may include a plurality of feeding networks. The plurality of feeding networks may be connected to each other in series and/or in parallel.

In a second connection manner, the signal processing module includes the feeding network and the filter unit. The following three optional connection solutions are illustrated:

Solution 1: A feeding network and a filter unit included in the signal processing circuit are connected in a one-to-one manner. For example, the antenna, the feeding network, and the filter unit are connected in sequence; or the antenna, the filter unit, and the feeding network are connected in sequence.

Solution 2: A feeding network and a plurality of filter units included in the signal processing circuit are connected in a one-to-many manner. In other words, the feeding network is separately connected to the plurality of filter units. Alternatively, the feeding network is connected to the plurality of filter units in any sequence.

Solution 3: A filter unit and a plurality of feeding networks included in the signal processing circuit are connected in a one-to-many manner. In other words, the filter unit is separately connected to the plurality of feeding networks. Alternatively, the filter unit is connected to the plurality of feeding networks in any sequence.

It should be noted that a connection manner of the feeding network and/or the filter unit in the signal processing circuit provided in this application includes any one of the foregoing connection manners or includes any combination of the foregoing connection manners.

For example, the signal processing circuit includes a plurality of feeding networks and a plurality of filter units. The filter units and the feeding networks are connected in sequence in an alternate manner. In addition, components located at the ends of the signal processing circuit are separately connected to the radio frequency unit and the antenna. If two filter units are located at the ends, the two filter units are separately connected to the radio frequency unit and the antenna. If two feeding networks are located at the ends, the two feeding networks are separately connected to the radio frequency unit and the antenna. If a feeding network and a filter unit are located at the ends, the feeding network may be connected to the radio frequency unit (or the antenna) and the filter unit may be correspondingly connected to the antenna (or the radio frequency unit) as required. Optionally, the filter units and the feeding networks are separately connected. Specifically, a filter unit 1 to a filter unit k are connected in sequence, the filter unit k is connected to a feeding network 1, and the feeding network 1 to a feeding network g are connected in sequence. In other words, the filter unit 1, a filter unit 2, . . . , the filter unit k, the feeding network 1, a feeding network 2, . . . , and the feeding network g are connected in sequence, where both k and g are greater than or equal to 1, and k and g may be equal or may be unequal. Optionally, the signal processing circuit further includes a filter unit and a plurality of feeding networks that are connected in a one-to-many manner, and/or a feeding network and filter units that are connected in a one-to-many manner.

The signal processing module provided in the embodiments of this application may include one, two, or more signal processing circuits. In addition, when different signal processing circuits exist, different signal processing circuits may be identical or different in terms of quantities and arrangement sequences of feeding networks and filter units. For example, a signal processing circuit includes only one feeding network, a signal processing circuit includes one feeding network and one filter unit, and a signal processing circuit includes two feeding networks and one filter unit. Different choices may be made as required.

The feeding network provided in the embodiments of this application may include different components. In an implementation solution, the feeding network includes a phase shifter and/or a power splitter. Specifically, the feeding network may include only the phase shifter, only the power splitter, or both the phase shifter and the power splitter.

The antenna provided in the embodiments of this application includes a spliceable antenna bay, to adapt to requirements in different scenarios. The spliceable antenna bay means that the antenna bay can work independently as an antenna or a plurality of antenna bays can be spliced to work coordinately. Therefore, two or more antenna bays can be randomly spliced to work coordinately based on requirements in different scenarios. Optionally, the antenna may include a plurality of spliceable antenna bays.

The antenna bay provided in the embodiments of this application may include a plurality of antenna units of different types. The antenna units of different types may work in a same frequency or in different frequencies. The antenna bay may be arranged in a spatially compact manner based on dimensional characteristics of different antenna units, so as to accommodate as many antenna units as feasible in a unit volume, thereby saving space resources of the antenna bay. A plurality of antenna bays can be flexibly spliced to form different antennas, so as to adapt to different scenarios.

The antenna unit provided in this application may be a single-band antenna unit, a dual-band antenna unit, or a multi-band antenna unit. When the antenna bay includes a dual-band antenna unit or a multi-band antenna unit, a single antenna unit can process signals of two or more frequencies. Compared with an antenna bay that includes only single-band antenna units, the antenna bay in this application works in more diversified frequency bands. It can be understood that antennas in a unit volume have a stronger service capability. This is equivalent to that the space resources of the antenna bay are being further fully utilized.

According to a second aspect, a signal processing module is provided. The signal processing module is the signal processing module according to any one of the first aspect or the implementations of the first aspect described above.

According to a third aspect, a communications system is further provided. The communications system includes the antenna apparatus according to any one of the implementations described above.

In the solutions of this application, the radio frequency unit and the antenna are connected by using an integrated signal processing module. The signal processing module may be integrated with components such as the filter, the duplexer, and the feeding network. Components for processing signals are integrated by using the signal processing module, to improve the integration degree of the antenna apparatus, thereby achieving a high integration degree. In addition, the signal processing module uses a pluggable manner to facilitate replacement. The antenna includes the spliceable antenna bay. Therefore, the antenna apparatus can use different signal processing modules based on requirements of different scenarios and matching antennas can be replaced at the same time. For example, antenna replacement can be implemented by splicing antenna bays. This improves flexibility and adaptability of the antenna apparatus and also facilitates more convenient replacement of the antenna apparatus.

### BRIEF DESCRIPTION OF DRAWINGS

FIG. 1 is a structural block diagram of an antenna apparatus according to an embodiment of this application;

FIG. 2 is a schematic diagram illustrating a usage state of an antenna apparatus according to an embodiment of this application;

FIG. 3 is a structural block diagram of an antenna apparatus according to an embodiment of this application;

FIG. 4 is a structural block diagram of an antenna apparatus according to an embodiment of this application;

FIG. 5a is a structural block diagram of an antenna apparatus according to an embodiment of this application;

FIG. 5b is a structural block diagram of an antenna apparatus according to an embodiment of this application;

FIG. 6 is a structural block diagram of an antenna apparatus according to an embodiment of this application;

FIG. 7 is a structural block diagram of an antenna apparatus according to an embodiment of this application;

FIG. 8 is a schematic diagram illustrating splicing of antenna bays according to an embodiment of this application;

FIG. 9 is a side view of an antenna according to an embodiment of this application;

FIG. 10 is a top view of an antenna according to an embodiment of this application; and

FIG. 11 is a structural block diagram of an antenna apparatus according to an embodiment of this application.

### DESCRIPTION OF EMBODIMENTS

The following describes some terms in this application:

(1) A network device is a device on a wireless network. For example, a terminal is connected to a radio access network (RAN) node of a wireless network. Currently, some examples of the RAN node are a base station, a transmission/reception point (TRP), an evolved NodeB (eNB), a radio network controller (RNC), a node B (NB), a base station controller (BSC), a base transceiver station (BTS), a home evolved NodeB (for example, home evolved NodeB or home Node B, HNB), a baseband unit (BBU), or a wireless fidelity (Wi-Fi) access point (AP). In a network structure, the network device may be a RAN device that includes a centralized unit (CU) node or a distributed unit (DU) node or includes both a CU node and a DU node.

(2) “A plurality of” means two or more. Other quantifiers have similar interpretations. “And/or” describes an association relationship for describing associated objects and represents that three relationships may exist. For example, A and/or B may represent the following three cases: Only A exists, both A and B exist, and only B exists.

The following further describes in detail this application with reference to accompanying drawings.

An antenna apparatus provided in the embodiments of this application is applied to a network device and can be used in different communication scenarios, with improved flexibility and adaptability.

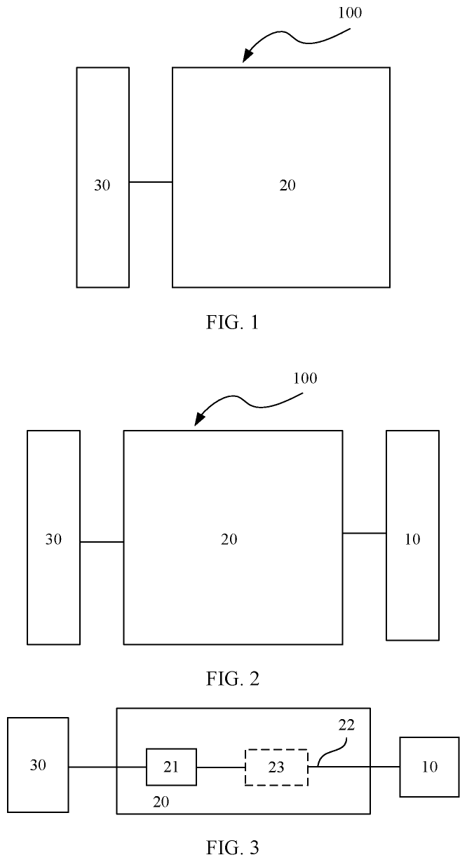

In referring to FIG. 1 and FIG. 2, FIG. 1 is a schematic structural diagram of an antenna apparatus 100 according to an embodiment of this application. FIG. 2 is a reference diagram illustrating a usage state of the antenna apparatus 100 according to an embodiment of this application. In the structure shown in FIG. 1, the antenna apparatus 100 includes a signal processing module 20 and an antenna 30. The signal processing module 20 is configured to perform feeding for a signal received or to be sent by the antenna 30. The antenna 30 is configured to send or receive the signal. Also referring to FIG. 2, when the antenna apparatus 100 is being used, the signal processing module 20 is connected to a radio frequency unit 10. When the antenna apparatus 100 is configured to transmit a signal, the radio frequency unit 10 is configured to provide a signal to be sent by the antenna 30, the signal processing module 20 is configured to process the signal and transfer the processed signal to the antenna 30, and the antenna 30 is configured to transmit the signal. When the antenna apparatus 100 receives a signal, the signal flows in a direction opposite to the direction of transmitting a signal. In the antenna apparatus 100 provided in the embodiments of this application, some components, for example, the passive components such as a feeding network and a filter, are integrated to form the signal processing module 20. Different components may be disposed on the signal processing module 20 to adaptively process a signal between the radio frequency unit 10 and the antenna 30. In some specific implementations, the signal processing module 20 includes a signal processing circuit 22. The signal processing circuit 22 is separately connected to the radio frequency unit 10 and the antenna 30.

It can be learned that the signal processing module is formed by integrating the passive components, and the module is pluggable. Different signal processing modules can be flexibly replaced, to adapt to different communication scenarios. In addition, when a component such as the feeding network or the filter is aged or damaged, only the signal processing module needs to be unplugged for repair or replacement, facilitating convenient repair or replacement.

When the signal processing module 20 includes a feeding network 21, different connection manners may be available. For example, in a first connection manner, the signal processing module includes the feeding network. As shown in FIG. 3, the signal processing circuit 22 includes the feeding network 21 (where a dashed box in FIG. 3 indicates that a filter unit 23 is an optional component that may be provided or not provided). The feeding network 21 is separately connected to the radio frequency unit 10 and the antenna 30. The feeding network 21 may include different components, for example, a phase shifter and a power splitter (not shown in the figure). In this way, the feeding network 21 can implement phase shifting and power splitting effects, and can implement power splitting and phase shifting for different antenna apparatuses when being connected to the antenna 30. Alternatively, the feeding network 21 may include only the phase shifter, only the power splitter, or another component such as a coupler. This is not limited in this application.

Certainly, the signal processing module may include a plurality of feeding networks. The plurality of feeding networks may be connected to each other in series and/or in parallel.

Optionally, the signal processing circuit 22 may further include another module in addition to the feeding network 21. Still referring to FIG. 3, the signal processing circuit 22 includes the feeding network 21 and the filter unit 23. In certain specific implementations of the filter unit 23, different filter components may be used, for example, a filter or a duplexer (not shown in the figure). In actual disposition, different filter units 23 may be selected based on a required scenario and connected to the feeding network 21.

When the signal processing module includes the feeding network and the filter unit, the following three optional connection solutions are illustrated: Solution 1: A feeding network and a filter unit included in the signal processing circuit are connected in a one-to-one manner. For example, the antenna, the feeding network, and the filter unit are connected in sequence; or the antenna, the filter unit, and the feeding network are connected in sequence. As shown in FIG. 3, when the signal processing circuit 22 includes one filter unit 23 and one feeding network 21, the feeding network 21 is connected to the antenna 30, and the corresponding filter unit 23 is connected to the radio frequency unit 10. Certainly, except the connection manner shown in FIG. 3, alternatively, the feeding network 21 may be connected to the radio frequency unit 10, and the corresponding filter unit 23 may be connected to the antenna 30.

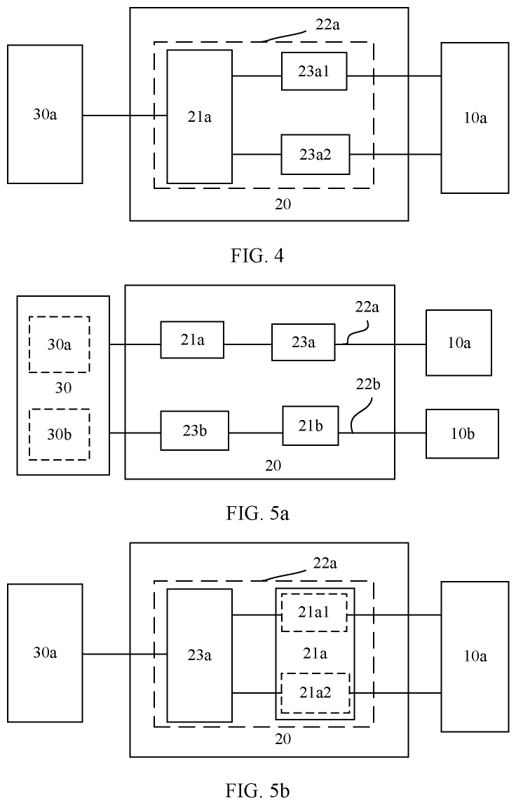

In addition, the feeding network 21 and the filter unit 23 in the signal processing circuit 20 may alternatively be connected in another manner. For example, a feeding network and a plurality of filter units included in the signal processing circuit are connected in a one-to-many manner. In a specific one-to-many connection manner, two specific connection manners are available. In one manner, the feeding network is separately connected to the plurality of filter units. As shown in FIG. 4, a signal processing circuit 22a includes one feeding network 21a and two filter units: a first filter unit 23a1 and a second filter unit 23a2. During connection, the feeding network 21a is connected to the antenna 30a, the first filter unit 23a1 and the second filter unit 23a2 are disposed in parallel, and two ends of each of the first filter unit 23a1 and the second filter unit 23a2 are separately connected to the feeding network 21a and the radio frequency unit 10a. In one specific example of signal connection, the feeding network 21a may be connected to the first filter unit 23a1 and the second filter unit 23a2 by using selective switches, or directly connected to the first filter unit 23a1 and the second filter unit 23a2 separately. In this case, the feeding network 21a includes a power splitter. Optionally, the feeding network may be connected to the plurality of filter units in any sequence.

Besides the foregoing one-to-many manner between the feeding network and the filter units, a filter unit and feeding networks may further be connected in a one-to-many manner. In other words, in this case, one filter unit corresponds to a plurality of feeding networks. Correspondingly, in a manner, the filter unit is separately connected to the plurality of feeding networks. As shown in FIG. 5b, when a filter unit included in a signal processing circuit 22 is a duplexer, with reference to FIG. 5b and FIG. 5a, as an example for description, a filter unit 23a included in a signal processing circuit 22a in FIG. 5a is a duplexer. For example, the signal processing module 20 includes one signal processing circuit 22a, and the signal processing circuit 22a includes a duplexer 23 a and a feeding network 21a. The feeding network 21a can be configured to receive a signal and send a signal at the same time. Alternatively, the feeding network 21a includes a feeding subnetwork 21a1 and a feeding subnetwork 21a2. Two channels of the duplexer are separately connected to the feeding subnetwork 21a1 and the feeding subnetwork 21a2. The feeding subnetwork 21a1 is configured to process the received signal, and the feeding subnetwork 21a2 is configured to process a to-be-sent signal. Alternatively, the feeding subnetwork 21a1 is configured to process a to-be-sent signal, and the feeding subnetwork 21a2 is configured to process the received signal.

It can be learned that when the filter unit included in the signal processing circuit 22 is a duplexer, signal receiving and signal sending of the antenna apparatus are processed separately in the signal processing module 20. Compared with the prior art in which a duplexer is integrated into a radio frequency unit, this can reduce the volume of the radio frequency unit 10. In addition, a duplexer is a main component that generates heat in the radio frequency unit 10. Therefore, when the radio frequency unit 10 does not include a duplexer, the heat of the radio frequency unit 10 can be reduced. This is conducive to heat dissipation of the radio frequency unit 10. Moreover, this simplifies design requirements on the radio frequency unit 10 and also reduces power consumption of the radio frequency unit 10. Furthermore, the signal processing module in this application is pluggable. Therefore, when the duplexer is damaged or aged, the signal processing module can be unplugged, facilitating convenient repair or replacement. Alternatively, the signal processing module may be replaced based on another applicable scenario.

When the filter unit 23a is a wideband filter or a dual-band filter, still referring to FIG. 5b, for example, the filter unit 23a may operate in a first frequency band and a second frequency band. The signal processing module 20 includes one signal processing circuit 22a. The signal processing circuit 22a includes the filter unit 23a and the feeding network 21a. The feeding network 21a can operate in the first frequency band and the second frequency band at the same time. Alternatively, the feeding network 21a includes the feeding subnetwork 21a1 and the feeding subnetwork 21a2. The feeding subnetwork 21a1 operates in the first frequency band, the feeding subnetwork 21a2 operates in the second frequency band, and the filter is separately connected to the feeding subnetwork 21a1 and the feeding subnetwork 21a2. That the filter can operate in two frequency bands illustrated in this embodiment of this application is merely an example. The filter 23a may alternatively operate in one frequency band or a plurality of frequency bands.

FIG. 5b shows a case in which the signal processing module 20 includes one signal processing circuit 22a. The signal processing module 20 may alternatively include a plurality of signal processing circuits. The signal processing circuits may be identical or different in terms of included components and quantities of the components. This is not limited in this application.

In addition, the filter unit may alternatively be connected to the plurality of feeding networks in any sequence.

It should be noted that the signal processing circuit provided in this application may use any one of the foregoing connection manners or any combination of the foregoing connection manners.

For example, the signal processing circuit includes a plurality of feeding networks and a plurality of filter units. The filter units and the feeding networks are connected in sequence in an alternate manner. In addition, components located at the ends of the signal processing circuit are separately connected to the radio frequency unit and the antenna. If two filter units are located at the ends, the two filter units are separately connected to the radio frequency unit and the antenna. If two feeding networks are located at the ends, the two feeding networks are separately connected to the radio frequency unit and the antenna. If a feeding network and a filter unit are located at the ends, the feeding network may be connected to the radio frequency unit (or the antenna) and the filter unit may be correspondingly connected to the antenna (or the radio frequency unit) as required. Optionally, the filter units and the feeding networks are separately connected, specifically in the following sequence: “a filter unit 1, a filter unit 2, . . . , a filter unit k, a feeding network 1, a feeding network 2, . . . , and a feeding network g”. In other words, the filter unit 1 to the filter unit k are connected in sequence, the filter unit k and the feeding network 1 are connected to each other, and the feeding network 1 to the feeding network g are connected in sequence, where both k and g are greater than or equal to 1, and k and g may be equal or may be unequal. Optionally, the signal processing circuit further includes a filter unit and a plurality of feeding networks that are connected in a one-to-many manner, and/or a feeding network and filter units that are connected in a one-to-many manner.

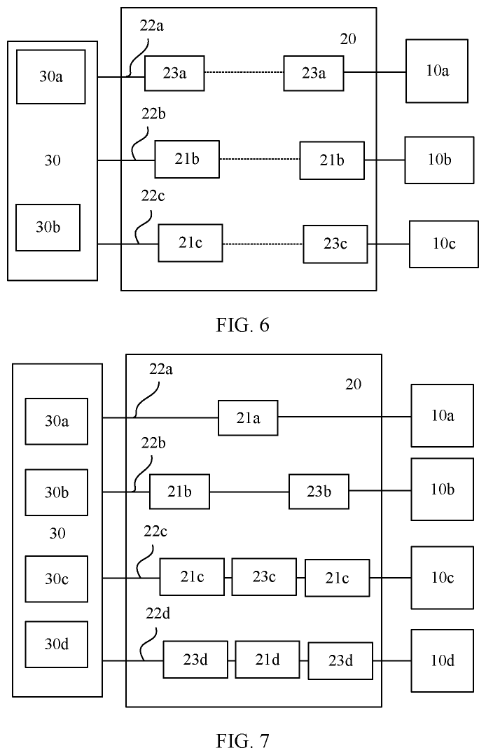

Optionally, when the signal processing circuit includes a plurality of filter units and a plurality of feeding networks, the filter units and the feeding networks may be arranged as required. For example, the filter units and the feeding networks are arranged in an alternate manner. For example, there is one feeding network 21 and two filter units 23, there are two feeding networks 21 and one filter unit 23, or there are two or more feeding networks 21 and two or more filter units 23. A feeding network 21 and a filter unit 23 are disposed in an alternate manner. In addition, components located at ends of the signal processing circuit 22 are connected to the radio frequency unit 10 and the antenna 30. As shown in FIG. 6, an ellipsis on each signal processing circuit represents an omitted intermediate component, including a filter unit and a feeding unit. Two filter units 23a are located at the ends of a first signal processing circuit 22a, and the two filter units 23a are separately connected to a radio frequency unit 10a and the antenna 30. Two feeding networks 21b are located at the ends of a second signal processing circuit 22b, and the two feeding networks 21b are separately connected to a radio frequency unit 10b and the antenna 30. When a feeding network 21c and a filter unit 23c are located at the ends of a third signal processing circuit 22c, the feeding network 21c is connected to the antenna 30 and the filter unit 23c is connected to a radio frequency unit 10c. Optionally, alternatively, the feeding network 21c may be connected to the radio frequency unit 10c, and the filter unit 23c may be correspondingly connected to the antenna 30 as required. Alternatively, for example, in another arrangement manner, a filter unit 23, a filter unit 23, and a feeding network 21 are arranged in sequence. Alternatively, for example, in another arrangement manner, a filter unit 23, a feeding network 21, a filter unit 23, and a filter unit 23 are arranged in sequence. These are merely examples here. Quantities and arrangements of filter units 23 and feeding networks 21 are not limited in this application. As shown in FIG. 6, the antenna 30 provided in this embodiment of this application may include an antenna bay 30a and an antenna bay 30b. The antenna 30 shown here is merely an example. The antenna 30 may further include an antenna bay 30c, an antenna bay 30d, an antenna bay 30e, and so on. The antenna bays may be identical or different. This is not limited in this application. Optionally, the antenna bays are spliceable. A plurality of antenna bays may be spliced based on requirements in different scenarios to form the antenna 30.

Optionally, the signal processing module 20 includes two or more signal processing circuits 22. For example, as shown in FIG. 5a, the signal processing module 20 includes two signal processing circuits 22: the first signal processing circuit 22a and the second signal processing circuit 22b. The feeding network 21a included in the first signal processing circuit 22a is connected to the antenna 30, and the filter unit 23a included in the first signal processing circuit 22a is connected to the radio frequency unit 10a. The feeding network 21b in the second signal processing circuit 22b is connected to the radio frequency unit 10b, and the filter unit 23b in the second signal processing circuit 22b is connected to the antenna 30. The feeding network 21a and the feeding network 21b may be identical or different in terms of structures, and/or the filter unit 23a and the filter unit 23b may be identical or different in terms of structures. This is not limited in this application. For example, the filter unit 23a is a filter, and the filter unit 23b is a duplexer. Optionally, the antenna 30 shown in FIG. 5a includes an antenna bay 30a and an antenna bay 30b.

The antenna bay 30a and the antenna bay 30b may be identical or different. In addition, the antenna 30 may further include other antenna bays. This is not limited in this application. Optionally, the antenna bays are spliceable. A plurality of antenna bays may be spliced based on requirements in different scenarios to form the antenna 30.

Optionally, when the signal processing module 20 includes a plurality of signal processing circuits 22, different signal processing circuits may be identical or different in terms of component types and component arrangement sequences. This can be disposed as required. As shown in FIG. 7, the signal processing module 20 includes four signal processing circuits 22. A first signal processing circuit 22a includes only a feeding network 21a, and the feeding network 21a is separately connected to the antenna 30 and a radio frequency unit 10a. A second signal processing circuit 22b includes a feeding network 21b and a filter unit 23b. The feeding network 21b is connected to the antenna 30, and the filter unit 23b is connected to a radio frequency unit 10b. A third signal processing circuit 22c includes two feeding networks 21c and one filter unit 23c that is located between the two feeding networks 21c. The two feeding networks 21c are separately connected to the antenna 30 and a radio frequency unit 10c. That the two feeding networks are both feeding networks 21c is merely an example. The two feeding networks may be designed based on an actual requirement. The two feeding networks may be identical or different in terms of structures. A fourth signal processing circuit 22d includes two filter units 23d and a feeding network 21d that is located between the two filter units 23d. The filter units 23d are separately connected to the antenna 30 and a radio frequency unit 10d. It should be understood that FIG. 7 only lists implementations of several different signal processing circuits. In actual application, different signal circuits may be selected based on a specific requirement, to process a signal. For example, a signal processing circuit in which a filter unit and feeding networks are connected in a one-to-many manner may be further included. Implementations are not limited to the examples in the accompanying drawings. Feeding networks 21 of different signal processing circuits 22 may be identical or different in terms of structures. Alternatively, filter units 23 of different signal processing circuits 22 may be identical or different in terms of structures. When a same signal processing circuit 22 includes a plurality of feeding networks 21, the feeding networks 21 in the signal processing circuit 22 may be identical or different in terms of structures. Alternatively, when a same signal processing circuit 22 includes a plurality of filter units 23, the filter units 23 in the signal processing circuit 22 may be identical or different in terms of structures. Optionally, as shown in FIG. 7, the antenna 30 may include an antenna bay 30a, an antenna bay 30b, an antenna bay 30c, and an antenna bay 30d. The antenna 30 here is merely an example. The antenna 30 may further include other antenna bays. The antenna bays may be identical or different. This is not limited in this application. Optionally, the antenna bays are spliceable. A plurality of antenna bays may be spliced based on requirements in different scenarios to form the antenna 30.

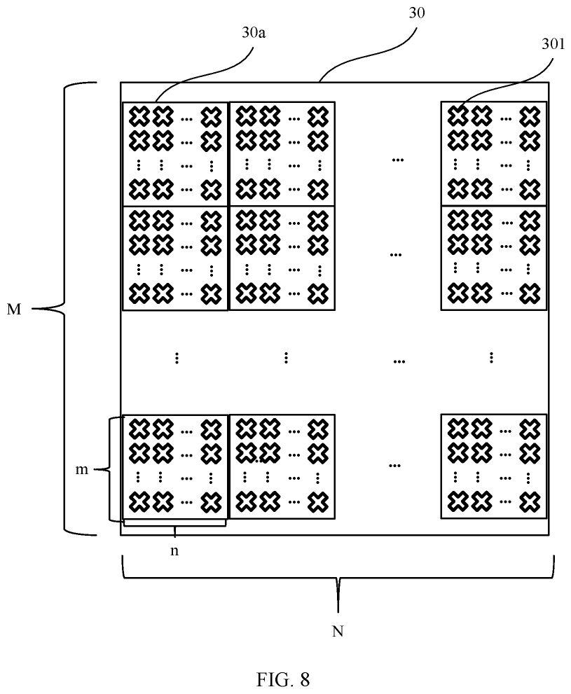

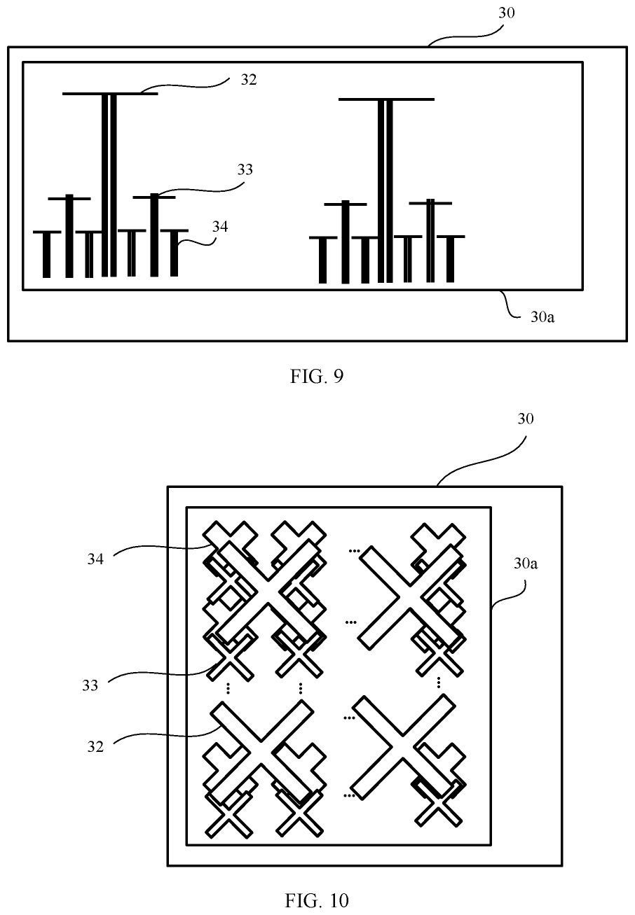

It can be learned that different signal processing modules 20 and a matching antenna 30 are selected based on an actual situation. The signal processing module 20 is connected to the antenna 30 and the radio frequency unit 10 in a pluggable manner. In this way, the signal processing module 20 can be replaced conveniently, to meet requirements in different scenarios. The antenna 30 provided in this embodiment of this application may include a plurality of spliceable antenna bays, so that the antenna bays and the signal processing module 20 are matched to adapt to a required scenario. A spliceable antenna bay means that the antenna bay uses a modular design structure. The antenna bay can work independently as an antenna or a plurality of antenna bays can be spliced to work coordinately. Antennas corresponding to different signal processing modules may include different or identical antenna bays. In this way, the antenna bays can be flexibly spliced as required, to adapt to requirements in different scenarios. For example, referring to FIG. 8, in a multiple-input multiple-output (MIMO) scenario, antenna bays 30a can be spliced to form an N×M antenna, to adapt to a scenario in which a quantity of sending and receiving channels is increased. Each antenna bay 30a includes n×m antenna units 301, where m, n, M, and N are all integers greater than or equal to 1, m and n may be identical or different, and/or M and N may be identical or different. For ease of description, the antenna bays 30a in FIG. 8 include only one type of antenna units 301. The antenna 30 is formed by splicing N×M antenna bays.

It can be learned that antenna bays can be spliced randomly to form an antenna, and a matching signal processing module is replaced at the same time, to meet requirements in different scenarios. It should be noted that the antenna bay 30a may include a plurality of types of different antenna units. FIG. 8 is merely an example. Antenna units and a periodic antenna bay arrangement manner shown in FIG. 8 are also merely examples. Antenna units and an arrangement manner of antenna bays are not limited in this application. A quantity of antenna units included in an antenna bay is not limited in this application, and a quantity of antenna bays included in an antenna is not limited either.

The antenna bay provided in the embodiments of this application may include a plurality of antenna units of different types. For example, the antenna units of different types may work in different frequencies. For another example, the antenna units of different types may be antenna structures in different forms, for example, a die-casting antenna structure and a dielectric antenna structure. The antenna bay may be arranged in a spatially compact manner based on dimensional characteristics of different antenna units, so as to accommodate as many antenna units as possible in a unit volume, thereby saving space resources of the antenna bay. A plurality of antenna bays can be spliced to form different antennas, so as to adapt to different scenarios.

An antenna unit provided in this embodiment of this application may be a single-band antenna unit, a dual-band antenna unit, or a multi-band antenna unit. During a specific implementation, the selection can be made as required. When the antenna bay includes a dual-band antenna unit or a multi-band antenna unit, a single antenna unit can process signals of two or more frequencies. Compared with an antenna bay that includes only single-band antenna units, the antenna bay in this application operates in more diversified frequency bands. It can be understood that antennas in a unit volume have a stronger service capability. This is equivalent to that the space resources of the antenna bay are being further fully utilized.

The following describes the antenna bay and the antenna unit provided in the embodiments of this application with reference to FIG. 9. An antenna 30 includes one antenna bay. The antenna bay includes three different types of antenna units: a first antenna unit 32, a second antenna unit 33, and a third antenna unit 34. During a specific implementation, the three different types of antenna units may be different types of antennas, or may be antennas of a same type, for example, all the three different types of antenna units are dipole antennas. It can be learned from FIG. 9 that the heights of different antenna units are different, so that the antennas may be arranged in a more compact manner, and the space resources of the antenna bay are fully utilized. It can be seen from FIG. 9 and a top view in FIG. 10 that the antenna units overlap in a same vertical space, so that space resources are fully utilized, the antennas is arranged in a more compact manner, and the antennas in a unit volume have a stronger service capability. As shown in FIG. 10, the first antenna unit 32 located in the middle is the highest, and the second antenna unit 33 and the third antenna unit 34 that are relatively low in height are located on both sides of the first antenna unit 32. In this way, the space is properly utilized, the density of the antenna 30 is improved, and the space occupied by the antenna 30 is reduced.

It can be learned that when a signal processing module 20 needs to be replaced, different antenna bays of the antenna 30 can be re-connected as required, so as to adapt to different scenarios.

To further improve understanding of the antenna apparatus in this application, the following provides description with reference to an example embodiment.

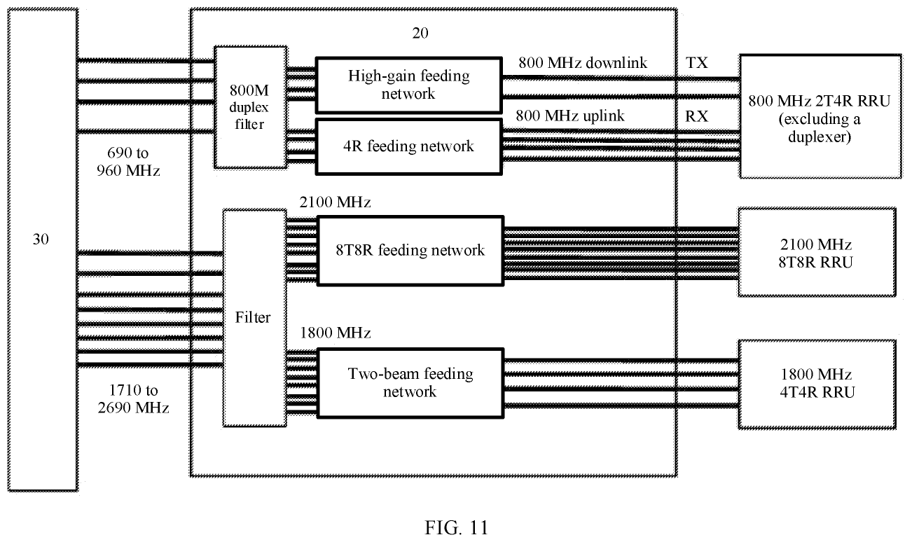

As shown in FIG. 11, a signal processing module 20 of an antenna apparatus includes two processing circuits 22.

One signal processing circuit 22 includes a duplexer and two feeding networks connected to the duplexer. In practice, an 800M duplex filter may be used to separately feed 800M uplink and downlink frequency band signals. 4T is used in the 800M downlink frequency band by using a high-gain feeding network, and 4R is used in the 800M uplink frequency band by using a feeding network 21. “T” represents transmit (transmit), and “R” represents receive (receive). For example, 4T4R or 8T8R configuration is well known to a person skilled in the art, and details are not described in this application again.

The other signal processing circuit 22 includes a filter and two feeding networks connected to the filter. Signals with a center frequency of 2100 MHz and signals with a center frequency of 1800 MHz are obtained from an antenna 30 through filtering and frequency division by using the filter. The signals with a center frequency of 2100 MHz are processed as 8T8R signals by using an 8T8R feeding network. The signals with a center frequency of 1800 MHz are processed into two 2T channels by using a two-beam feeding network. An 800M RRU excluding a diplexer may reduce the size, weight, and heat, and improve an RF indicator of the RRU.

The high-gain feeding network represents a relatively high gain of a feeding network, the 4R feeding network represents a 4-receive feeding network, the 8T8R feeding network represents an 8-transmit/8-receive feeding network, and the 2-beam feeding network represents a feeding network in which an antenna can radiate two beams. The feeding network included in the signal processing module shown in FIG. 11 is merely an example, and the name of the feeding network is not limited in this application.

In addition, this application provides a signal processing module. The signal processing module is any one of the foregoing signal processing modules. The signal processing module includes at least a feeding network. That is, the signal processing module may at least be configured to feed an antenna, and may further include a filter unit, so that filtering may be performed on a signal received or sent by the antenna. The signal processing module provided in this application may further include another component, such as another passive component, for example, a combiner. Any combination of a feeding network and/or a component such as a filter into a pluggable module falls within the protection scope of this application. The signal processing module provided in this application may be in a form of a chip.

In addition, an embodiment of this application further provides a communications system. The communications system includes the antenna apparatus according to any one of the embodiments described above, and/or the signal processing module according to any one of the embodiments described above.

In the solutions of this application, by using the antenna apparatus and the communications system provided in this application, the degree of integration of the signal processing module is improved. In particular, the integration of passive components is enhanced, and a pluggable manner is used to facilitate replacement. In addition, antenna bays included in an antenna may be spliceable, so that the antenna bays may be flexibly spliced based on requirements in different scenarios, to match different signal processing modules, so as to adapt to a required scenario. It can be learned that the antenna apparatus can use different signal processing modules flexibly and conveniently as required by an actual scenario, and flexibly adapt to different scenarios by splicing antenna bays.

The foregoing descriptions are merely specific implementations of this application. They are not intended to limit the protection scope of this application. Any variation or replacement that can be readily made by a person skilled in the art within the technical scope disclosed in this application shall fall within the protection scope of this application.

What is claimed is:

1. An antenna apparatus, comprising an antenna and a signal processing module, wherein the signal processing module is pluggable-ly connected to the antenna;
the signal processing module comprises a signal processing circuit configured to correspondingly connect a radio frequency unit to the antenna; and
the signal processing circuit comprises a feeding network.

2. The antenna apparatus according to claim 1, wherein the signal processing circuit further comprises a filter unit connected to the feeding network.

3. The antenna apparatus according to claim 2, wherein in the signal processing circuit,
the feeding network and the filter unit are connected in a one-to-one manner;
the feeding network and a plurality of filter units are connected in a one-to-many manner; or
the filter unit and the feeding networks are connected in a one-to-many manner.

4. The antenna apparatus according to claim 3, wherein the signal processing circuit comprises a plurality of feeding networks and a plurality of filter units, the filter units and the feeding networks are connected in sequence in an alternate manner, and components located at ends of the signal processing circuit are separately connected to the radio frequency unit and the antenna.

5. The antenna apparatus according to claim 2, wherein the filter unit is a duplexer or a filter.

6. The antenna apparatus according to claim 2, wherein the signal processing module comprises a plurality of signal processing circuits, and the plurality of signal processing circuits are the same or different.

7. The antenna apparatus according to claim 1, wherein the feeding network comprises a phase shifter and/or a power splitter.

8. The antenna apparatus according to claim 1, wherein the antenna comprises a spliceable antenna bay.

9. The antenna apparatus according to claim 8, wherein the antenna comprises a plurality of spliceable antenna bays.

10. The antenna apparatus according to claim 9, wherein each of the plurality of spliceable antenna bay comprises a plurality of antenna units of different types.

11. The antenna apparatus according to claim 10, wherein the antenna unit may be a single-band antenna unit, a dual-band antenna unit, or a multi-band antenna unit.

12. A communications system, comprising the antenna apparatus according to claim 1.
